(19) United States
(12) Patent Application Publication
(10) Pub. No.: US 2015/0363792 A1
(43) Pub. Date: Dec. 17, 2015

(54) Product Purchase Study Combining Active and Passive Purchase Data Sources

(71) Applicant: Google Inc., Mountain View, CA (US)

(72) Inventors: Nick Salvatore Arini, Southhampton (GB); Andrew Gilfind, London (GB); Simon Michael Rowe, Berkshire (GB)

(73) Assignee: Google Inc., Mountain View, CA (US)

(21) Appl. No.: 14/156,218

(22) Filed: Jan. 15, 2014

(51) Int. Cl. G06Q 30/02

(52) U.S. Cl. CPC G06Q 30/0201

(57) ABSTRACT

A method, implemented by a processor, for combining multiple data sources in a product purchase study includes acquiring, by a processor, first product purchase data for a product from a first data source, the first product purchase data uniquely identifying the product; sending, by the processor, the first product purchase data to a remote server; receiving, by the processor, a signal from the remote server based on the first product purchase data, the signal comprising a request for additional product purchase data; acquiring by the processor in response to the request, second product purchase data from a second source independent of the first source to the remote server; and sending the second product purchase data to the remote server.

### BACKGROUND

Media consumption and related behaviors by a population may be estimated based monitoring and analysis of such behaviors among members of an appropriately-designed and selected population sample. One such behavior is advertising effectiveness: does exposure to an advertisement by an individual lead that individual to take a specific action, including purchasing the advertised product or service.

Panels may be recruited to record various behaviors of the population sample. The sample data then may be used to estimate corresponding behaviors of the population. Ideally, the activities and actions of a recruited panelist would be followed from a first advertisement exposure to a purchase of a corresponding product.

### SUMMARY

A method, implemented by a processor, for combining multiple data sources in a product purchase study includes acquiring, by a processor, first product purchase data for a product from a first data source, the first product purchase data uniquely identifying the product; sending, by the processor, the first product purchase data to a remote server; receiving, by the processor, a signal from the remote server based on the first product purchase data, the signal comprising a request for additional product purchase data; acquiring by the processor in response to the request, second product purchase data from a second source independent of the first source to the remote server; and sending the second product purchase data to the remote server.

A system for combining multiple data sources in support of a product purchase study includes a scan mechanism that captures first information encoded in a data element associated with a product subject to the study; a processing device that processes the captured, encoded information to produce unambiguous first product information related to the product; a secondary mechanism that operates to capture second information related to the product; the processing element that processes the captured second information to produce second product information related to the product; and a data transmitter that sends the first and second product information to a remote server.

A method for combining product data from multiple data sources in support of a product purchase study includes receiving, by a processor, from a first remote device, the first remote device comprising a first data source, first product information related to a product subject to the study, the first product information acquired directly from a scan of the product at the first remote device; receiving, by the processor, from a second remote device, the second remote device comprising a second data source independent of the first data source, second product information related to a purchase action taken with respect to the product; and combining, by the processor, the first and second product information to determine a completeness of the received first and second product information in unambiguously identifying the product, and determine compliance with product information collection requirements of the study by an operator of the first remote device.

### DESCRIPTION OF THE DRAWINGS

The detailed description refers to the following figures in which like numerals refer to like items, and in which:

FIG. 1 illustrates an environment that supports recording, studying, and evaluating product purchase information in support of a product purchase study;

FIGS. 2A-2C are block diagrams illustrating an example system and components thereof in which product purchase information from multiple sources may be recorded, studied, and evaluate;

FIGS. 3A and 3B illustrate example components of a server-side product purchase system that may be used to combine product purchase source information to support a product purchase study and

FIGS. 4-6 are flow charts illustrating methods for recording, studying, and evaluating panelist product purchase behavior.

### DETAILED DESCRIPTION

Media consumption and related behaviors by a population may be estimated based monitoring and analysis of such behaviors among members of an appropriately-designed and selected population sample. Such a population sample may be referred to as a panel, and its members as panelists. Panelists may receive some form of compensation or other incentive for their participation in a panel.

A panel may be designed to determine advertising effectiveness: does exposure to an advertisement by a panelist lead that panelist to take a specific action, including purchasing the advertised product or service. Because knowing advertising effectiveness is an important element in designing and evaluating an advertising campaign, advertisers and media delivery companies may invest in large scale versions of panels to measure advertising effectiveness through randomized experiments. Part of evaluation involves determining the sales lift for products in response to an advertising campaign. This sales lift determination may require collection of product purchase information. In a large scale panel, advertising exposure among the panelists may be controlled. The panelists may be split into two groups: a first, or exposed group that may be exposed to certain advertisements, and a second, or control group for which the advertisements are suppressed. Using these two groups, a panel operator may be able to run experiments where some proportion of the panelists is exposed to certain advertisements, and the rest of the panelists do not see the advertisements. Then, panelist purchase behaviors are monitored, and some correlation between ad exposure and corresponding product purchases may be made as part of the advertising effectiveness study.

One problem with purchase panels is compliance by panelists with panel requirements for active collection of product purchase information. Collecting product purchase information may be so burdensome that some panelists may ignore the panel's information collection requirements. For example, some purchase panels require panelists to type in their purchases. Other purchase panels supply the panelists with a scanner to scan their applications. The scanner may a standalone barcode scanner or smart phone with a barcode scanning application, for example. Other alternatives are applications which run on a mobile phone or personal computer and use the camera on the phone to take a picture of a product or product receipt. All of these alternatives may impose such a burden on panelists, that full compliance may be difficult. One mechanism for improving active information collection compliance is increasing incentives paid to the panelists; thus, compliance costs may increase the more onerous an information collection requirement as higher incentives may need to be paid to the panelists.

The scanned information may be provided to a product purchase system. The product purchase system may include a product barcode database and a mechanism for comparing scanned barcodes to the product barcode database.

One possible alternative to active information collection by panelists is to invoke one or more passive collection mechanisms. Passive collection mechanisms may be less onerous to panelists; however, passive mechanisms may not be as comprehensive in terms of data collection as full compliance active collection (e.g., scanning) by the panelists. Thus passive measurement may have the advantage of good compliance but the disadvantage of possibly incomplete coverage; active measurement may have the advantage of more complete coverage but the disadvantage of incomplete compliance.

To enhance the efficacy of purchase panel experiments such as for determining advertising effectiveness, disclosed herein are systems and methods that combine data collection from active and passive sources. The systems and methods provide high coverage and high compliance at a reasonable cost. The systems and methods may use a combination of passive and active sources of data for the same panelist and may combine these sources in ways that minimize panelist burden and encourage compliance, and that additionally may provide cross reference checks for compliance.

With the herein disclosed systems and methods, product purchase information may be derived passively from transaction-level events (e.g., capturing transactional data at or subsequent to the point of sale) or actively from individual products (e.g., scanning by a panelist). In addition a purchase may be made either online or offline (e.g., at a store) with consequences as to the ease of information collection.

Transactional data may be easier to capture passively through sources such as credit card logs/statements. However, these passive data sources tend to not yield the far more relevant line item data required to investigate individual product/brand purchases.

Line item data (i.e., data for individual products) can be captured in a few different ways such as barcode scanning and receipt scanning (offline receipts or online email confirmations), and loyalty card data from the point-of-sale (POS).

While barcode scanning is a labor-intensive information capture mechanism for a panelist, it also yields (mostly) unambiguous, high fidelity, product information through a unique international article number (EAN) code or a similar code. Barcode data, however, lacks context on its own. For example, barcode data may not include date and place of purchase. Receipt scanning may be done in ways that reduce the panelist's burden, but the fidelity of the product information captured from this data source is weaker and more ambiguous than is barcode scanning (assuming the receipt has no barcode itself that may be scanned).

Accordingly, in one aspect, the systems and methods combine receipt scanning with barcode scanning as active information capture mechanisms. A panelist may be asked to scan receipts and may be prompted to barcode scan either products that cannot be resolved or a subset of random products in the list. This aspect reduces the overall number of scans the panelist is required to perform (load reduction) as well as providing an error correcting mechanism for the data quality and, over time, a database of product description to EAN links. Such receipt scanning also may provide context (merchant, time of purchase, etc.) to accompany the barcode scans. Other active mechanism include text and audio entry.

In a second aspect, the systems and methods provide for compliance checking; i.e., a check on whether and to what extent a panelist is complying with the panel's product purchase information collection requirements. Requiring manual barcode and receipt scanning by the panelist can result in non-compliance or partial compliance. Using transaction data such as credit card logs, the panel operator may use the systems and methods to identify compliance events or determine coverage. For example if a panel experiment requires scanning of consumer package goods (CPG) purchases and the system receives a record of a transaction at a grocery store but no corresponding CPG scans, the panel operator may use the systems to determine that the panelist is not fully complying with the information collection requirements of the panel experiment. Alternately, the panel operator may use the systems to match a “basket total” to the approximate value of products that may be estimated from barcode or receipt scanning. For example, the total paid for a basket of groceries (the basket total) may be compared to price paid information that may be derived from scanning of individual grocery items.

Many retailer use a loyalty card system to confer benefits from their repeat customers. Loyalty card data may provide itemized lists of purchases; however retailers may use different loyalty card schemes. To ensure complete coverage, the panel operator may desire access to the data from many different loyalty card schemes from different retailers. In yet another aspect, the panel operator may use the systems to infer coverage based on the transaction data derived from a loyalty card scheme: Assume a panel operator has a full list of transactions but only partial itemized data from one loyalty card retailer. The panel operator may know retailers that participate in the loyalty scheme and may know which retailers the panelist has visited. The panel operator may use the systems to analyze the transaction data and group the analyzed data by verticals. The panel operator then may determine coverage for a given type of purchase. For example, if a panelist shopped only for CPG products a grocery store and the panel operator has loyalty card data from grocery store, the panel operator may use the systems to infer complete CPG coverage.

In still another aspect, the panel operator may periodically (e.g., every 6 months) issue a traditional survey to the panelists, asking questions on what newspapers they buy and brands/foods they prefer, for example, as well as an amount the panelist spent on groceries each week. The answers from these data sources then can be cross-checked with the other logs to determine a likely level of panelist compliance. For example, if a panelist indicates in the survey that he is spending $200/week on groceries, but panel operator only sees scans/receipts for $60, the panel operator may use the systems to infer the panelist did not scan all products on which the panel experiment is based. Finally, the panel operator may issue targeted and contextual micro-surveys to spot check certain measurements or to address holes in scanned product purchased information.

In still another aspect, the panel operator may use the systems and methods to record, study and evaluate product purchase information while minimizing panelist burden by splitting a large purchase panel into panel subgroups, by rotating information collection requirements among the panel subgroups, and by limiting the number of products for which information is to be collected by the panelist.

Thus, the systems and methods provide the panel operator with mechanisms to use various combinations of data sources to address incomplete data (coverage) including identifying the incomplete data and obtaining data from different or additional data sources to fill in the incomplete data while at the same time maintaining a minimal overhead on the panelist.

These and other concepts are disclosed in more detail with reference to the following Figures.

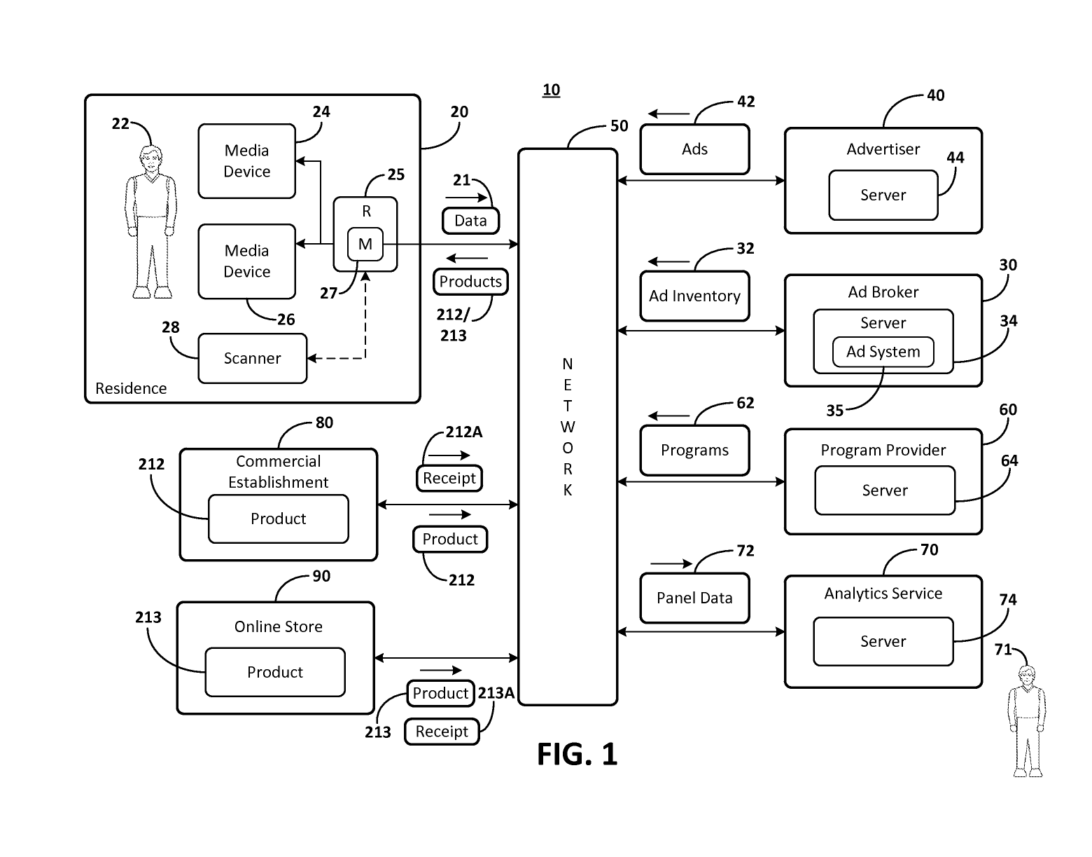

FIG. 1 illustrates an example environment in which consumer purchase behavior may be recorded, studied, and analyzed. In FIG. 1, environment 10 includes viewing location (residence) 20, ad broker 30, advertiser 40, program provider 60, and analytics service 70, all of which communicate over network 50. Also shown in FIG. 1 are commercial establishment 80 and online store 90 through both of which a panelist 22 may purchase products and services.

The residence 20 may include first media device 24 and second media device 26 through which panelist 22 receives advertisements 42 from advertiser 40 and programs 62 (e.g., videos) from program provider 60. At the residence 20, panelist 22 may operate media devices 24 and 26 to access, through router 25, resources such as Web sites and to receive television programs, radio programs, and other media and to make online product purchases. The media devices may be fixed or mobile. For example, fixed media device 24 may be an Internet connected smart television (iTV); a basic or smart television connected to a set top box (STB) or other Internet-enabled device; a Blu-ray™ player; a game box; a desk top computer, and a radio, for example. Mobile media device 26 may be a tablet, a smart phone, or a laptop computer, for example. The media devices 24 and 26 may include browsers (not shown). The browser may be a software application for retrieving, presenting, and traversing resources such as at the Web sites. The browser may record certain data related to the Web site visits. The media devices 24 and 26 also may include applications. The panelist 22 may cause the media devices 24 or 26 to execute an application, such as a mobile banking application, to access online banking services. The application may involve use of a browser or other means, including cellular means, to connect to the online banking services. Another application may provide active product purchase information collection features such as barcode scanning, for example.

The residence 20 may include a meter 27 that records and reports data collected during exposure of advertisements 42 and programs 62 to the panelist 22. The example meter 27 may be incorporated into the router 25 through which all media received at the residence 20 passes. Alternately, the panelist 22 may operate separate meters (not shown) for each media device. The meter 27 also may record online product purchase information. The meter 27 may send the collected data to the analytics service 70.

Also shown at the residence 20 is standalone scanner 28. The scanner 28 may be used to obtain and transmit data from products and services provided and purchased at the commercial establishment 80. Operation of the scanner 28, as well as the media devices 24 and 26, as part of a product purchase information collection system and corresponding method is described below.

Programs watched data, advertisements watched data, and product purchase information may be sent to the analytics service 70 as data file 21.

The determination of which advertisements 42 to serve with which programs 62 may depend in part on information related to the panelist 22 at the residence 20. This information may be provided by the panelist 22 voluntarily. For example, a panelist 22 may register with the advertiser 40 or otherwise agree to serve as a panelist and may provide information such as a password and user ID. In situations in which the systems disclosed herein collect personal information about the panelist 22, or may make use of personal information, the panelist 22 may be provided with an opportunity to control whether programs or features collect panelist information (e.g., information about a panelist's social network, social actions or activities, profession, a panelist's preferences, or a panelist's current location), or to control whether and/or how to receive advertisements that may be more relevant or of interest to the panelist 22. In addition, certain data may be treated in one or more ways before it is stored or used, so that personally identifiable information is removed. For example, a panelist's identity may be treated so that no personally identifiable information can be determined for the panelist 22, or a panelist's geographic location may be generalized where location information is obtained (such as to a city, ZIP code, or state level), so that a particular location of a panelist 22 cannot be determined. Thus, the panelist 22 may have control over how information is collected about the panelist 22 and used by a server.

The ad broker 30 provides an advertisement service, executed as an advertisement system 35 on server 34. The ad broker 34 sells ad inventory 32 to advertiser 40. The ad inventory 32 may appear in the programs 62.

The advertiser 40 operates ad server 44 to provide advertisements 42 that may be served with programs 62 provided by the program provider 60. For example, the server 44 may provide advertisements 42 to serve at Internet Web pages, in applications executing on the media devices 24 and 26, and in breaks in broadcast television programs. The advertiser 40 may represent a single company or entity, or a group of related companies.

The network 50 may be any communications network that allows the transmission of signals, media, messages, voice, and data among the entities shown in FIG. 1, including radio, linear broadcast (over-the-air, cable, and satellite) television, on-demand channels, over-the-top media, including streaming video, movies, video clips, and games, and text, email, and still images, and transmission of signals, media, messages, voice, and data from a media device to another media device, computer, or server. The network 50 includes the Internet, cellular systems, and other current and future mechanisms for transmission of these and other media. The network 50 may be both wired and wireless.

The program provider 60 operates server 64 to deliver programs 62 for consumption by the panelist 22. The programs 62 may be broadcast television programs, radio programs, Internet Web sites, or other media. The programs 62 may include provisions for serving and displaying advertisements 42; that is, the programs 62 may include ad inventory 32. The program provider 60 may receive the advertisements 42 from the advertiser 40 and may incorporate the advertisements 42 into the programs 62. Alternately, the panelist's media devices may request an advertisement 42 when those media devices display a program 62.

The analytics service 70, which through panel operator 71 operates analytics server 74, may collect data related to advertisements 42 and programs 62 to which a panelist 22 was exposed. In addition, the analytics service 70 may obtain product and service acquisition or purchase information as part of a product purchase study. The information may be obtained by the panelist 22 operating the standalone scanner 28 (e.g., at residence 20 or commercial establishment 80). In an embodiment, such information collection is performed through a panelist program where panelists 22 are recruited to voluntarily provide such information. The actual information collection also may be performed by way of surveys and/or by collection by the meter 27 in addition to the information collected by the scanner 28. In addition, panelist information related to product purchases may be acquired from other sources such as point-of-sale sources (e.g., online store 90 or commercial establishment 80), and credit card and banking sources. In an aspect, information collected from some of these sources may be by passive means, active means, or both. Programs/ads watched data and active/passive product purchase information is shown in FIG. 1 as panel data 72. The collected panel data 72 are sent to and stored in analytics server 74, which then processes the data.

Commercial establishment 80 may be a brick and mortar building in which a panelist 22 may purchase products and services (e.g., products 212). For example, the commercial establishment 80 may be a grocery store, and the panelist 22 may purchase various food products from the grocery store. Food product packaging typically includes a data element such as a barcode, which the panelist 22 may scan (e.g., using scanner 28 at the commercial establishment 80) when making a purchase. The commercial establishment 80 may provide receipt 212A with the purchased product 212. The receipt 212A may be provided by electronic means (e.g., email, browser) or manual means (hand the receipt 212A to the panelist 22). Although not shown in FIG. 1, the receipt may include a barcode or other data storage element that may be scanned by either the scanner 28 or the media device 26.

The panelist 22 also may scan barcodes of products purchased through channels other than on-site at the commercial establishment 80. For example, the panelist 22 may see a product in a magazine advertisement. The advertisement may include a barcode. The panelist 22 may scan the barcode to actually purchase the product; the panelist 22 also may scan the barcode as part of the product purchase process.

Another channel for product purchases is online store 90, which sells product 213 and provides receipt 213A. The product 213 and receipt 213A may include barcodes. In addition, an online view of the product 213 may include a barcode. In an embodiment, the online store 90 may be affiliated with or be a part of the commercial establishment 80; for example, the online store 90 may be an on-line version of a grocery store. Products 213 and receipts 213A may be provided to the panelist 22 using electronic means or physical means such as regular mail or pick up at the commercial establishment 80.

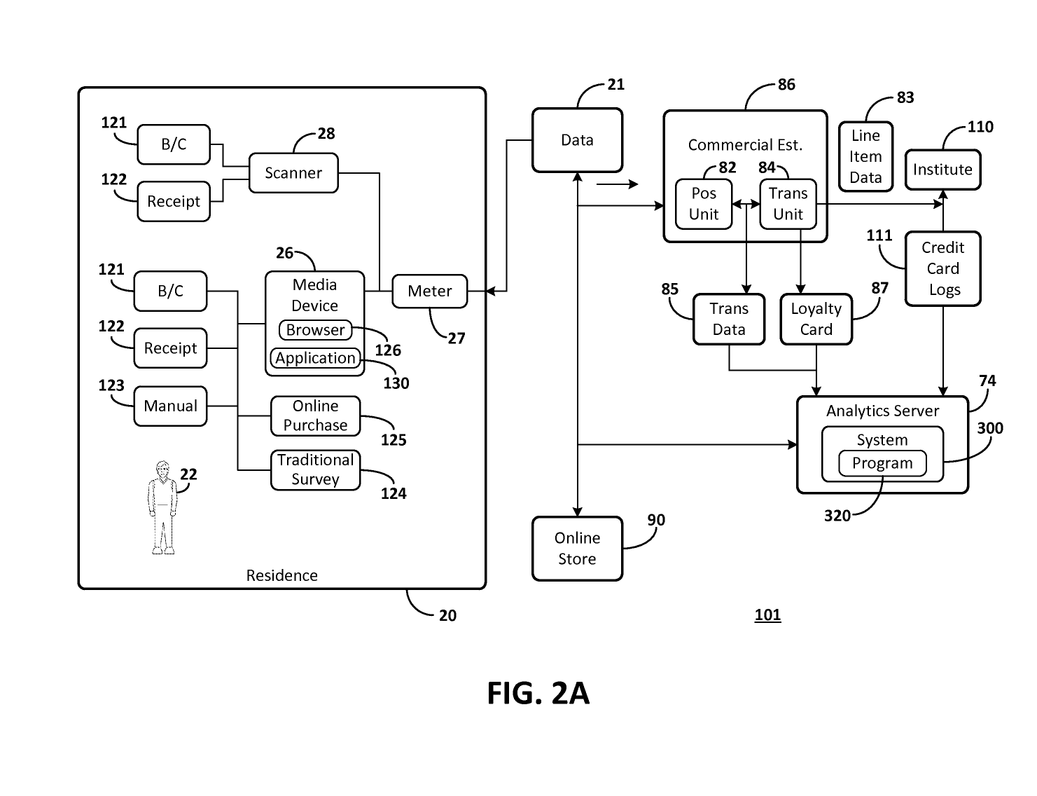

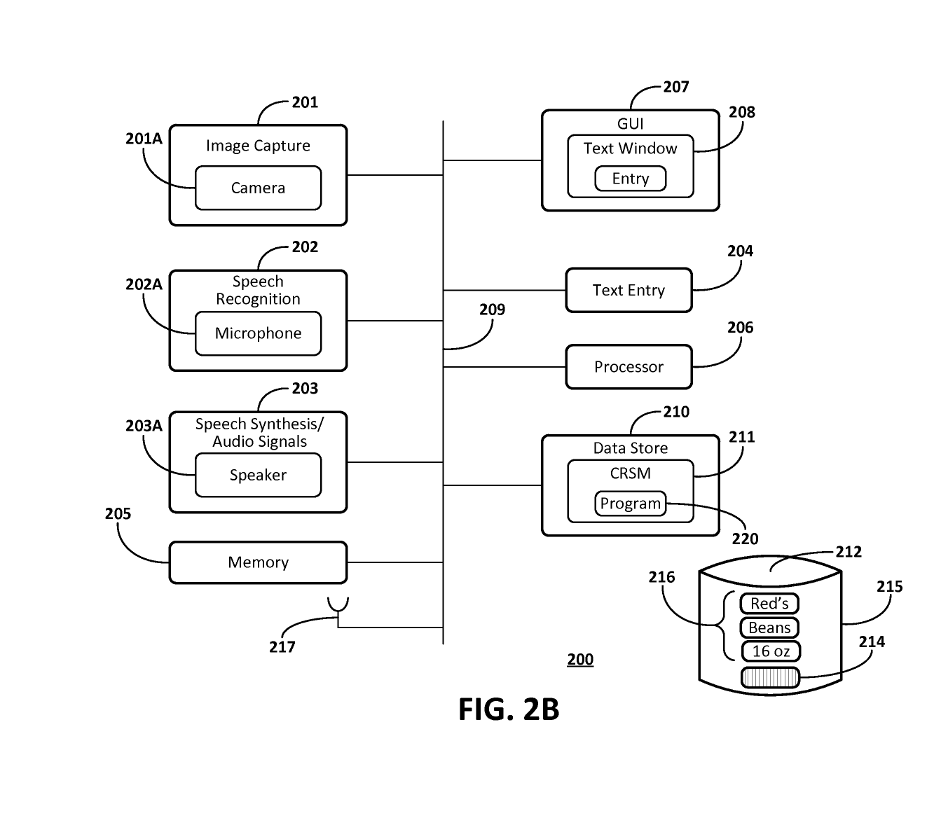

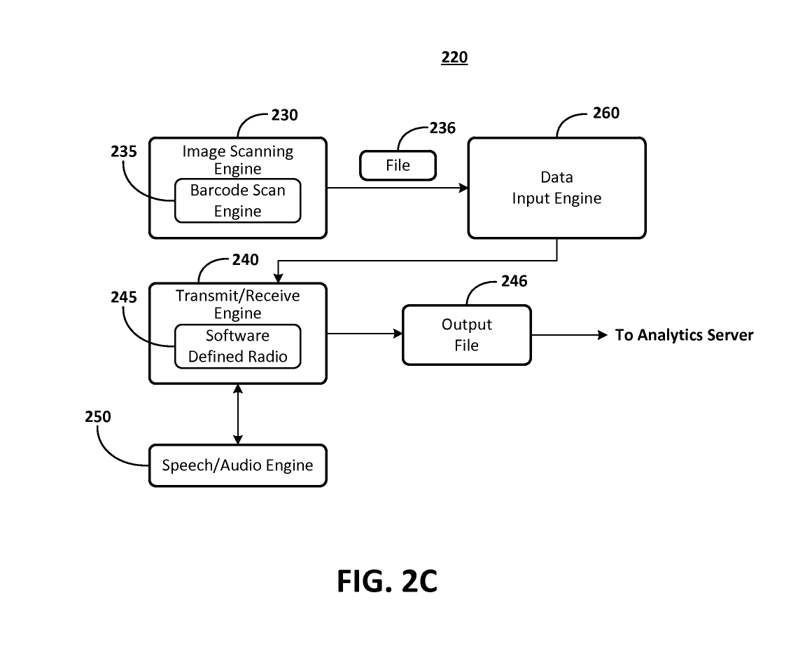

FIGS. 2A-2C are block diagrams illustrating example systems and components thereof that support a product purchase study using combined purchase data sources for enhanced coverage and compliance with panel information collection and recording requirements.

FIG. 2A is an overall diagram of select components of a system that enables a panel operator to conduct a product purchase study. In FIG. 2A, system 101 includes components at the residence 20, analytics service 70, commercial establishment 80, and online store 90, as in FIG. 1. In addition, the system 101 includes institute 110.

The scanner 28 may be used to scan barcodes on products and on receipts (product barcode 121 and receipt barcode 122, respectively). Mobile media device 26 also may be used to scan product barcodes 121 and receipt barcodes 122. Media device 26 also may be used to scan receipts, such as by image capture using a built-in camera system. Media device 26 also may be used to receive manual inputs 123 of product data by the panelist 22. Manual inputs 123 may involve use of text entry and audio entry mechanisms. Finally, a browser 126 in media device 26 may capture product purchase data from online purchases made by the panelist 22 using the media device 26. Meter 27 also may capture product purchase data from online purchases made by the panelist 22 using the media device 26. The panelist 22 also may be provided survey documents 124 to complete as part of the product purchase study. The survey documents 124 may be provided in hard copy form (e.g., by mail) or electronically (e.g., email or from a Web site operated by the analytics server 74). The completed survey documents 124 may be returned by mail or by electronic means.

In some aspects, fixed media device 24 (see FIG. 1) may be used to supply some of the functions of mobile media device 26 with respect to recording and providing product purchase information to the analytics server 74.

The panelist 22 may make purchases from the commercial establishment 80 and the online store 90. When making the purchases at the commercial establishment 80, the panelist 22 may be required by the panel's product information collection procedures to use the scanner 28 or media device 26 to capture product data such as barcode data or other product data. The panel's product information collection procedures may require such information capture to occur at the point-of-sale (i.e., at the commercial establishment 80).

The above-described product purchase information collection mechanisms and processes may be considered active mechanisms and processes in that the panelist 22 takes an active role in the information collection (e.g., by scanning).

As an alternative or a supplement to the active product purchase information collection processes executed by the panelist 22, the system 101 may use passive mechanisms and processes for capturing product purchase information. As applied to the commercial establishment 80, such passive mechanisms may include use of a point-of-sale (POS) unit 82 that captures certain product purchase information and provides that information to transaction unit 84. The POS unit 82 may include a barcode scanner and a credit card reader, and the credit card reader may capture certain product purchase information for purchases made by the panelist 22 and charged to a credit card of the panelist 22. The POS unit 82 may send single line item information to the transaction unit 84. The transaction unit 84 may send purchase information 83 to institute 110, where the information 83 may recorded as a single line item and from where approval to complete the transaction is made. For example, the information 83 may be the total paid for a basket of groceries, and may say nothing about individual items purchased by the panelist 22 at the grocery store.

In an embodiment, a panelist 22 purchasing groceries at commercial establishment 80 may have a bonus or loyalty card that applies price reductions on certain grocery items (CPGs). The loyalty card may have as a data element, a simple barcode. The panelist 22 may have the loyalty card scanned at the POS unit 82. The scan may identify the panelist 22 as a loyal customer. The loyalty card barcode also may have coded thereon information 87 identifying the panelist 22. The identifying information 87 may be sent from the POS unit 82 or the transaction unit 84 to the analytics server 74.

The panel operator 71 (e.g., at the analytics service 70) may receive the totalized data from the institute 100 (e.g., credit card logs 111), or perhaps more detailed data 85, including data for individual grocery items, from the POS unit 82. However, retailers operating stores such as the commercial establishment 80 may record data in differing formats, and not all information may be useable at the analytics service 70.

Finally, the panel operator may receive product purchase information 21 from the panelist 22; for example, the panelist 22 may provide the results of barcode scans at the commercial establishment 80. Such panelist-provided data may be in real-time as the scanning occurs, or at a later time.

In terms of fidelity of the captured product purchase information compared to the actual product, each of the mechanisms described above with respect to FIG. 2A has advantages and disadvantages. Barcodes 21: on the one hand, scanned barcodes may not indicate an actual point-of-sale location, when the sale occurred, or the price paid for the associated product, including a reduced price for a sale item or because of application of a coupon or loyalty card. However, a scanned barcode may indicate a recommended price. Furthermore, the analytics service 70 may not be able to cross a scanned barcode to an actual product so as to identify the product. For example, manufacturers may not make such barcode-to-product data available to the analytics service 70 and thus, the analytics service 70 may need to identify products and establish a product-to-barcode mapping on their own. Still further, scanned barcode information may not be assembled easily into a basket total. On the other hand, scanned barcodes generally will record data very accurately, with little chance for error created by panelist mistakes in the information collection process.

POS detail data 85: on the one hand, this data source may indicate date, location, and price information. In addition, the POS detail data 85 may indicate basket totals. On the other hand, POS detail data collection may burden retailers and may not accurately describe a product (e.g., the data may not differentiate between an 11 oz. can of beans and a 22 oz. can of beans).

Credit card line item data 83/111: on the one hand, this data may provide good basket totals and may be easily collected and used in the product purchase study. On the other hand, the data may not differentiate between multiple products purchased at a single POS unit.

Thus, the systems and method described herein may use more than one data source to enhance data completeness and compliance. The systems and methods provide this enhancement to the product purchase study while reducing the burdens imposed on panelists

FIG. 2B illustrates an example client-side product purchase system 200 for use by a panelist. In FIG. 2B, system 200 may be implemented in whole or in part in the scanner 28. Alternately, all or part of the system 200 may be incorporated into mobile media device 26.

System 200 includes image capture device 201, speech recognition device 202, speech/audio synthesis device 203, text entry device 204, memory 205, processor 206, graphical user interface (GUI) 207, including text entry window 208, communications bus 209 linking the above devices, data store 210, and transmit/receive antenna 217. The above noted devices may be implemented in hardware.

The data store 210 may include a non-transitory computer-readable medium 211 on which resides product purchase program 220. The program 220 is described elsewhere herein including with respect to FIG. 2C.

Also shown in FIG. 2B is an example of a product 212. The product 212 is contained in package 215. The package 215 includes a data element, which in an embodiment is barcode 214, and product descriptive information 216. The example product 212 is a quantity of beans and the package 215 is a can with a paper wrapper on which are printed the barcode 214 and the product descriptive information 216, which may include a brand name, a product name, and a product quantity. The barcode 214 may be a one-dimensional barcode or a two-dimensional barcode. The barcode 214 may have associated a text field (not shown) in which are inserted numerals corresponding to the barcode 214.

In an alternate embodiment, the data element associated with or affixed to product 212 may be a passive RFID tag, and the system 200 may be configured to read data from the RFID tag. Other data elements also may be used in place of the barcode 214.

Products other than product 212 (i.e., other than a can of beans) may be subjected to processing by the system 200. For example, the same can of beans may be advertised in a magazine. The system 200 may be used to scan a barcode provided with the advertisement to order the can of beans over the Internet. The same scanning operation may provide the barcode data to analytics server 74. This scanning operation may include use of mechanisms for additional entry of product information. Such mechanisms may include text and voice information entry mechanisms. Thus, the herein disclosed systems may be used to collect product purchase data in virtually any scenario and over virtually any channel.

Image capture device 201 may include a camera 201A that is capable of supporting barcode scanning and image capture of the barcode 214 and image capture of the entire package including the product descriptive information 216.

Speech recognition device 202 includes a microphone 202A that is capable of receiving speech from the panelist 22, and audio signals.

Speech/audio synthesis device 203 includes a speaker 203A through which sounds and synthesized voice may be provided.

Text entry device 204 may be a keyboard implemented as a soft keyboard (i.e., as a GUI) or a hard keyboard (i.e., buttons), and other text entry components such as a pointing device.

Memory 205 holds instructions for execution by processor 206.

Processor 206 executes instructions of program 220 to record and report panelist purchase behavior to the analytics service 70.

Graphical user interface (GUI) 207, in addition to displaying a soft keyboard, provides text entry window 208 and associated control features. The text entry window 208 may display a pre-formatted text entry form, pull down menus, and other components that allow the panelist 22 to quickly, efficiently, and accurately enter secondary product data (e.g., product descriptive information 216) related to product 212.

The transmit/receive antenna 217 sends signals and data to a remote server and receives signals back from the remote server.

Communications bus 209 links the above devices to allow signals and data to pass among the devices.

FIG. 2C illustrates example components of product purchase program 220. The program 220 may be incorporated into the scanner 28, the media device 26, and/or the meter 27 of FIG. 2A. The components may include modules having machine instructions executed by processor 206. Certain of the components may interact with the hardware devices shown in FIG. 2B.

The program 220 includes image scan engine 230, transmit/receive engine 240, speech/audio engine 250, and data input engine 260. The image scan engine 230 operates with the camera 201A of image capture device 201 to capture images of product 212 or receipt 212A. The camera 201A works in a conventional sense to capture the product descriptive information 216. Thus, the image scan engine 230 generates a digital scan file 236 representing the product descriptive information 216.

In an embodiment, the engine 230 includes barcode scan engine 235. The barcode scan engine 235 operates to read barcode 214. The scanned data, in the form of scan file 236 then may be passed to data input engine 260. The image scan engine 230 also may provide a rendering of the barcode 214 to the data input engine 260.

Transmit/receive engine 240 provides communications outside the media device hosting the system 200. The engine 240 optionally includes software defined radio (SDR) 245. Software defined radios are well known in the art, and in general, SDR 245 does not require further explanation herein. Other data communications mechanisms such as a browser may be used in place of the SDR 245. The transmit/receive engine 240 sends digitized data (e.g., from barcode 214) in the form of output file 246 to and receives digitized data from analytics server 74.

Speech/audio engine 250 works with speech recognition device 202 and speech synthesis/audio signal device 203 to convert analog signals to digital signals and digital signals to analog signals. The engine 250 also may convert digital files to text or image files for display to the panelist 22 on GUI 207.

Data input engine 260 provides any further processing of data collected through a scanning process or through a manual data entry process. In addition, the engine 260 may include a checking feature that compares data from a current data scanning process to data from prior data scanning processes to ensure consistency of data input.

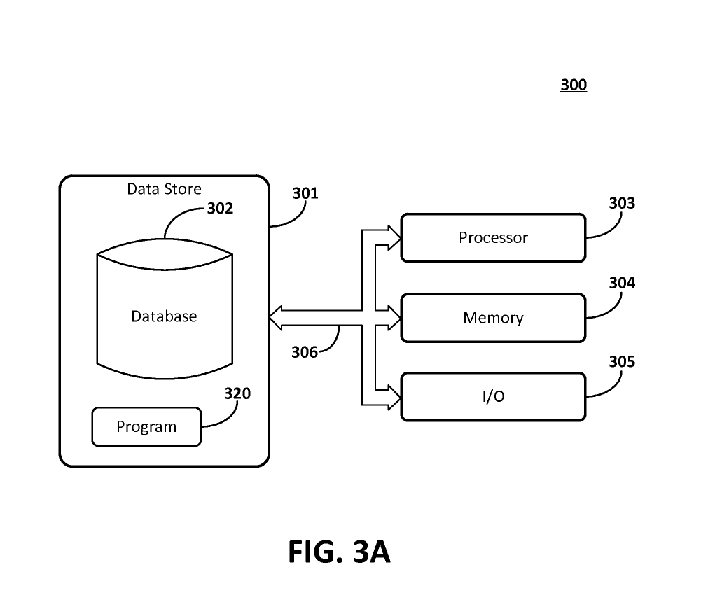

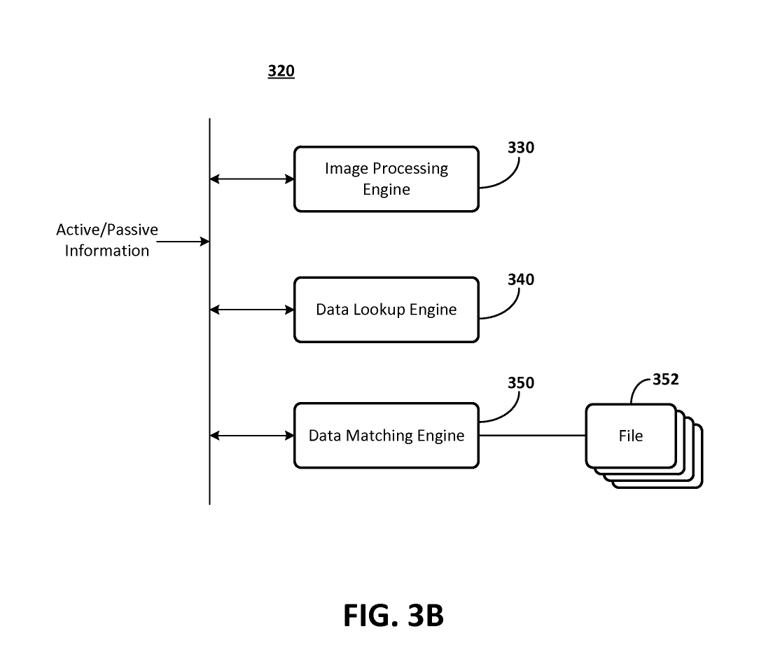

FIGS. 3A and 3B illustrate an example server-side product purchase system. In an embodiment, server-side product purchase system 300 is implemented on analytics server 74.

In FIG. 3A, the system 300 includes data store 301, processor 303, memory 304, and input/output (I/O) 305. These components are linked by communications bus 306.

The data store 301 includes database 302 and product purchase program 320, which is described elsewhere herein, including with reference to FIG. 3B.

The database 302 stores, among other data product description/barcode data that allows components of the system 300 to identify, using a first modality, a purchased product based on a scanned barcode or other scanned product information.

The processor 303 reads instructions of program 320 into memory 304 and executes the instructions.

The I/O 305 allows machine and human interaction with the system 300.

The bus 306 provides for signaling and data transfer among components of the system 300.

FIG. 3B illustrates an example of product purchase program 320. The program 320 receives product purchase data 21 (e.g., including the digital files 246) primarily from panelists such as panelist 22, and provides feedback to the panelists. The program 320 also receives product purchase information form passive information collection sources such as the POS unit 82 of FIG. 2A

The program 320 includes image processing engine 330, data lookup engine 340 and data matching engine 350. The image processing engine 330 receives digital files 246 corresponding to scanned barcodes contained on products 212 or the receipts 212A and image data (e.g., product descriptive information 216) for certain products 212 when, for example, a barcode is not recognized in the database 302 or a recognized barcode does not provide sufficient information for the product purchase study. The image processing engine 330 may pass the barcode data to the data lookup engine 340. When the incoming data 246 includes, for example, a digital image of product 212, the engine 330 may extract data from the image, such as product brand, name, and size. When the incoming data includes a text transmission, the engine 330 may extract data, such as brand, name, and size, from data fields provided in the text transmission.

Data lookup engine 340 compares the received barcode 214 to data in the database 302 to determine if the barcode 214 exists in the database 302 such that the barcode can be crossed to a specific product. If a match is found, the engine 340 extracts relevant product data from the stored barcode entry. For example, a stored barcode entry may include product brand, product name, and product size. The engine 340 passes the barcode 214 and, where appropriate, the existence of a match and the associated product data, to data matching engine 350.

Data matching engine 350 performs several functions to support a product purchase analysis and its larger product purchase study. The engine 350 verifies that received barcodes correspond to products that currently are part of a product purchase study. For example, a two-month product purchase study may be designed to collect product purchase information for non-perishable (as opposed to fresh) food products. Should a panelist 22 provide barcode data for a non-food product or for a fresh food product, the engine 350 may note the discrepancy. However, the system 300 still may store the barcode data with the product description in the database 302.

The data matching engine 350 collects information from multiple data sources (passive and active) and assembles the information into a file 352 that represents product purchase behavior of a panelist 22 for a given time and for a defined product list according to a product purchase study. The engine 350 may provide this function for all panelists 22 assigned to the product purchase study. The engine 350 further may aggregate the information from each such file 352 to create an overall view of product purchase behavior among the panelists 22.

The data matching engine 350 may identify incomplete data entries for each file 352, and may attempt to acquire additional information to address those entries. For example, the engine 350 may create a file 352 for CPG purchases by a panelist 22 and populate the file 352 with barcode scan data from the panelists. However, the thus-created file 352 may lack context information (date and time of purchase, purchase location, price paid). The engine 350 them may attempt to retrieve or acquire context information from other sources, including credit card information from institute 110 or POS unit 82, receipt information from POS unit 82, and other data sources. Note that these data may be pulled from the institute 110 and commercial establishment 80, respectively, or may be pushed from the institute 110 and commercial establishment 80 to the analytics service 70. When the data are pushed, the data may arrive at the analytics service 70 at different times and may be stored in the database 302 until needed by the engine 350. When all available data are received, the engine 350 may execute to analyze the product purchase behavior of the panelist 22. One aspect of the analysis is determining to what extent the panelist 22 has complied with the product purchase study information collection requirements.

At the conclusion of a product purchase analysis, the engine 350 may store all appropriate data in the database 302.

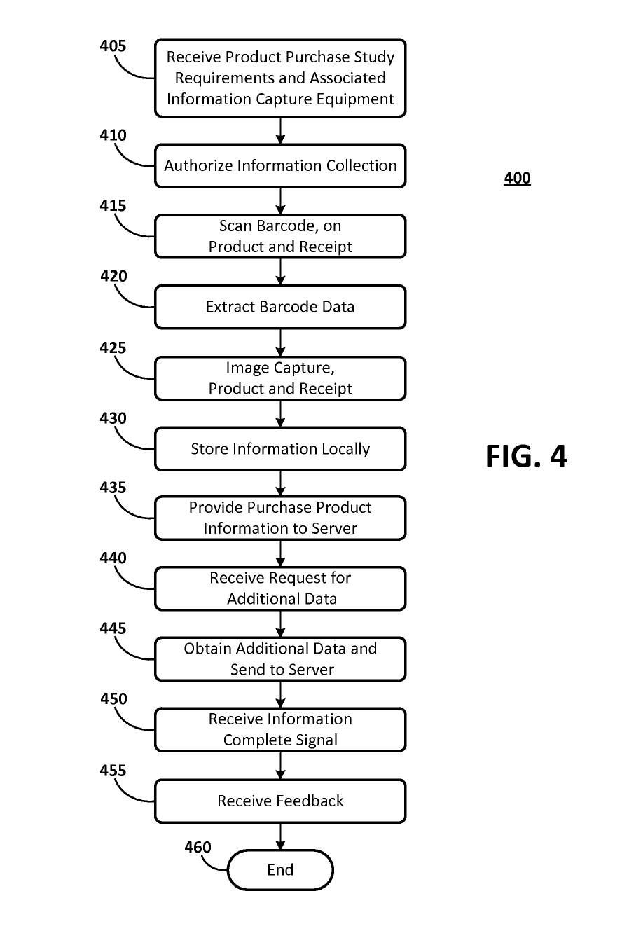

FIGS. 4-6 are flow charts illustrating example product purchase study methods. The methods of the flow charts are described with respect to the systems, devices, and entities of FIGS. 1-3B. The methods further assume that panelists, such as panelist 22, have been instructed to provide product purchase information for a specific product or class of products purchased though one or more specified avenues or networks. For example, a product purchase study may be defined as a two-month period in which panelists 22 record product purchase information for non-perishable food products (e.g., CPGs).

In FIG. 4, client-side product purchase method 400 begins in block 405 when panelist 22 receives product purchase study requirements and, if needed, information capture components such as scanner 28 or scanning application for installation on the media device 26. The requirements may specify a product list by specific products or class of products. For example, the study requirements may specify information collection by barcode scanning for CPG products purchased online and at commercial establishments such as a grocery store. Other active information collection requirements may include imaging receipts, scanning barcodes on receipts, and providing text entry or audio entry of data related to purchased products. However, the active information capture requirements may be structured to minimize the burden placed on the panelists 22. The requirements also may specify what secondary or passive information capture sources are to be used in the study and may ask each panelist 22 to authorize such passive data collection, if needed. Examples of passive information include loyalty card information, credit card information, and POS information.

In block 410, the panelists, as necessary, provide authorization to acquire information using the requested passive collection techniques. In block 415, the panelist 22 purchases a product from the list and performs the requested active information collection processes, including scanning product barcode 214. In block 420, the panelist's information capture equipment, where appropriate, retrieves barcode data related to the products purchased. For example, when the panelist 22 scans barcode 214 for product 212, the scanned data are processed by system 200 and are stored in a first file to be sent to system 300 on server 74. If barcode scanning is by a dedicated scanner such as the scanner 28, the first file may be stored in the barcode scanner 28 as an intermediate storage process. Alternately, the first file may be transferred to the media device 26 for subsequent transfer to the system 300. In another alternative, the first file may be transferred in real time or near real time to the system 300. In block 425, the panelist 22 optionally performs additional active information capture processes including image capture of a receipt 212A, scanning a receipt barcode, and text entry, for example. In block 430, the system 200 stores the captured information in a second file to be sent to the system 300. In an embodiment, the first and second files are the same file; that is, data from the scanner 28 and media device 26, for example, may be stored in a single file at the media device 26. Data from the scanner 28 thus may be sent from the scanner 28 to the media device 26 as an intermediate data transfer process.

In block 435, the system 200, if not done previously, transfers the first and second files (or a combine file) to the system 300.

In block 440, the system 200 receives a request from the system 300 for additional data related to the purchased product. The request may specify the format and data entry means to be used to provide the additional data. For example, the request may ask the panelist 22 to upload a digital image of the receipt 212A. In block 445, the panelist 22 performs the requested additional information collection process and the system 200 creates an additional information file to send to the system 300. The additional file may be sent to the system 300 when saved in the system 200 (e.g., in near real time), or at a later time (e.g., a batch transfer).

In block 450, the system 200 receives an information complete signal for the product purchase, and provides an alert to the panelist 22 (e.g., in a window displayed on the media device 26). In block 455, the system 200 may receive feedback from the system 300 regarding any non-compliance issue related to the product purchase. The feedback may be provided in a window displayed on the media device 26. In block 460, the system 200 then may delete the first, second, and subsequent files related to the product purchase. In block 465, the method 400 ends.

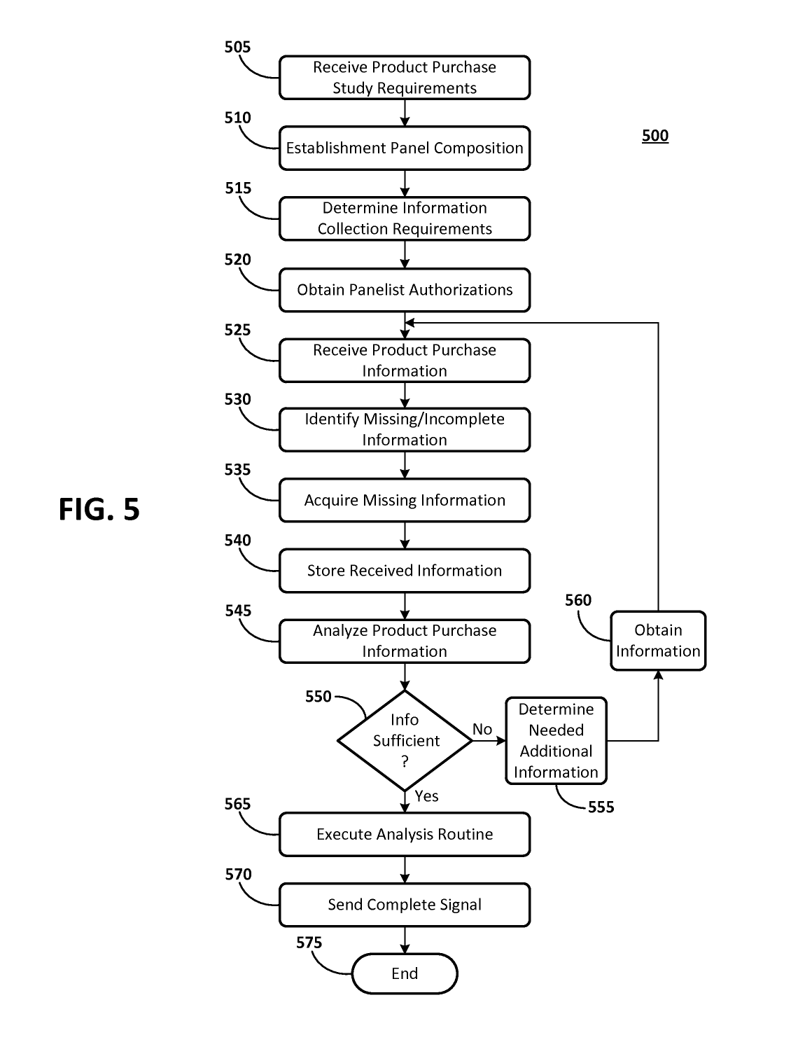

In FIG. 5, server-side product purchase method 500 begins in block 505 when the system 300 receives product purchase study requirements from the panel operator 71. The panel operator 71 may provide the requirements by manual entry using a graphical user interface, for example. In an aspect, the panel operator may provide a list of products or a class of products to be studied, and the system may generate a set of both active and passive information capture requirements. For example, a product to be studied may be identified by an EAN. The system 300 then may determine what information sources are available (e.g., barcode scanning, credit card line item) and sufficient to complete a product purchase study for the product or class of products. In block 510, the system may identify, using various algorithms, historical data and manual inputs from the panel operator 71, what the panel composition should be, the length of the study, and other related parameters. The system 300 then, under control of the panel operator 71 may recruit panelists for the study, identify any information collection devices the panelists 22 may need (e.g., scanner 28, downloadable scanning application for installation on media device 26) and may provide the devices to the panelists 22.

In block 515, the system 300 determines information collection requirements for the study and provides the requirements to the panelists 22. Note that the panel may include multiple sub groups such as a purchase sub group and a control sub group, and the information collection requirements for the sub groups may differ. In block 520, the system 300 may obtain, if needed, authorization from panelists 22 to receive product purchase information from passive sources (e.g., credit card line item information).

In block 525, the system 300 begins receipt of product purchase information. The information may arrive from passive and active sources and may arrive at different times and in different formats. In block 530, the system 300 analyzes the information to identify any missing information relative to the information collection requirements of the study. In this context, missing information may include a corrupt barcode scan file, for example. In block 535, the system 300 may attempt to acquire the missing information. For example, the system 300 may send an alert to the panelist to rescan a product barcode. In block 540, the system 300 may store the received product purchase information, including any requested additional information in a file in database 302.

In block 545, the system 300 analyzes the information in the file for completeness and compliance with information collection requirements of the study. In block 550, the system 300 determines if the collected information is sufficient to complete the designed study analysis as well as analysis of completeness and compliance. If, in block 550, the information is not sufficient, the method 500 moves to block 555 and the system 300 determines what additional information collection is needed. The method then moves to block 560 and the system 300 attempts to obtain the needed information from available data sources as defined in block 505. The method 500 then returns to block 525.

In block 550, if the collected product purchase information is sufficient, the method 500 moves to block 565 and the system 300 executes a product purchase analysis routine and stores the analysis results in the database for subsequent use, updating, and evaluation. In block 570, the system 300 sends a product purchase process signal to the panelist 22, and in block 575, method 500 ends.

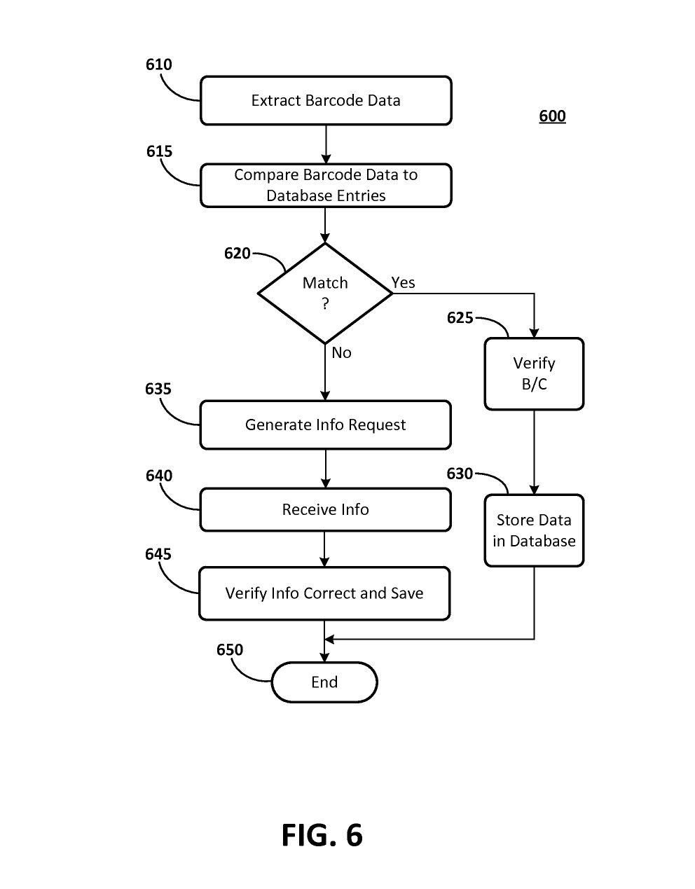

FIG. 6 is a flow chart illustrating additional aspects of a product purchase study method executed on the server side. In FIG. 6, method 600 begins in block 610, when the system 300 extracts the barcode data associated with the purchased product 212. In block 615, the system 300 compares the barcode data to entries in database 302 and in block 620 determines if a match exists. If, in block 620, a match is found, the method 600 moves to block 625 and the system 300 verifies the barcode corresponds to product purchases being monitored as part of the current product purchase study. The system 300, in block 630, stores the product purchase data as part of the two-month product purchase study.

In block 615, if a match is not found, the method 600 moves to block 635 and the system 300 generates a request for additional product information and serves the request to the panelist 22. In block 640, the system 300 receives the requested additional product purchase information from the system 200. The additional product purchase information may include brand name, product name, and size, for example. In block 645, the system 300 verifies the additional product purchase information is correct, that the product purchased corresponds to products being monitored as part of the product purchase study, and saves the barcode and associated product information in database 302. Following block 645, the method 600 moves to block 650 and ends.

In the preceding discussion, product purchase study processes are described primarily with respect to collecting barcode data associated with a purchased product. As noted above, the barcode need not be affixed to the product or the product packaging, such as might be the situation where a product being purchased is advertised or offered in hard copy or electronic format along with a barcode as part of the advertisement or offer. Thus, a product purchase study may be designed to identify products purchased through a magazine, for example. In such a study, the barcode may include data identifying the location of the product (here, in a magazine) being purchased. The barcode thus provided may correspond in all respect to a barcode provided on a package for the product, with the exception of having additional location data included. One mechanism for including the location data may be a watermark that encodes the location.

In an embodiment, the product purchase processes use a barcode to identify a product being purchased. However, data elements other than barcodes may be used. For example, a product package may include a passive radio frequency identification (RFID) tag, a watermark, or a hologram that encodes product data. Thus, the systems and methods disclosed herein may use any data element having embedded or encoded product data to identify a product being purchased so long as those data can be perceived and recorded by a properly programmed device.

Certain of the devices shown in FIGS. 1, 2A, 2B, and 3A include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAM) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to flow charts and accompanying description to illustrate the embodiments represented in FIGS. 4-6. The disclosed devices, components, and systems contemplate using or implementing any suitable technique for performing the steps illustrated. Thus, FIGS. 4-6 are for illustration purposes only and the described or similar steps may be performed at any appropriate time, including concurrently, individually, or in combination. In addition, many of the steps in the flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

We claim:

1. A method, implemented by a processor, for combining multiple data sources in a product purchase study, comprising:
acquiring, by a processor, first product purchase data for a product from a first data source, the first product purchase data uniquely identifying the product;
sending, by the processor, the first product purchase data to a remote server;
receiving, by the processor, a signal from the remote server based on the first product purchase data, the signal comprising a request for additional product purchase data;
acquiring by the processor in response to the request, second product purchase data from a second source independent of the first source to the remote server; and
sending the second product purchase data to the remote server.

2. The method of claim 1, further comprising:
receiving by the processor a scan of a data element associated with the product; and
processing the electronic scan to produce the first product purchase data.

3. The method of claim 2, wherein the data element is a barcode affixed to a package of the product.

4. The method of claim 2, wherein the data element is a barcode in an advertisement for the product.

5. The method of claim 2, wherein the data element is a RFID tag.

6. The method of claim 1, further comprising sending the first and second product purchase data in substantially real time with respect to the acquiring.

7. The method of claim 1, wherein the second product purchase data are acquired by manual text entry by a panelist.

8. The method of claim 1, wherein the second product purchase data are acquired by speech entry by a panelist.

9. A system for combining multiple data sources in support of a product purchase study, comprising:
a scan mechanism that captures first information encoded in a data element associated with a product subject to the study;
a processing device that processes the captured, encoded information to produce unambiguous first product information related to the product;
a secondary mechanism that operates to capture second information related to the product; and
the processing element that processes the captured second information to produce second product information related to the product; and
a data transmitter that sends the first and second product information to a remote server.

10. The system of claim 9,
wherein the scan mechanism comprises a barcode scanner and the secondary mechanism comprises an image capture device; and
wherein the data element is a barcode.

11. A method for combining product data from multiple data sources in support of a product purchase study, comprising:
receiving, by a processor, from a first remote device, the first remote device comprising a first data source, first product information related to a product subject to the study, the first product information acquired directly from a scan of the product at the first remote device;
receiving, by the processor, from a second remote device, the second remote device comprising a second data source independent of the first data source, second product information related to a purchase action taken with respect to the product; and
combining, by the processor, the first and second product information to:
determine a completeness of the received first and second product information in unambiguously identifying the product, and
determine compliance with product information collection requirements of the study by an operator of the first remote device.

12. The method of claim 11, further comprising:
comparing the first product information to product data entries in a product database to determine a match between the first product information and a product data entry; and
identifying the product based on based on a determined match.

13. The method of claim 12, wherein the first product information comprises information embedded in a data element associated with the product, the method further comprising:
processing the first product information to extract an identification of the product; and
comparing the identification to the product data entries.

14. The method of claim 12, wherein the first product information comprises product identification information for the product, the product identification produced by processing the embedded information at the remote device.

15. The method of claim 11, wherein the second remote device comprises a point-of-sale (POS) device that records purchase data associated with the purchase action for the product, the method further comprising receiving the purchase data as the second product information.

16. The method of claim 15, wherein the purchase data comprises an amount charged on a credit card during the purchase action.

17. The method of claim 15, wherein the purchase data comprises receipt information for a receipt for a purchase of the product generated during the purchase action.

18. The method of claim 11, wherein the method further comprises:
establishing product purchase information requirements for panelists participating in the study;
determining an extent of compliance for each of the panelists with the product purchase information requirements; and
sending a prompt to panelists having a determined extent of compliance less than the requirements.

19. A computer-readable storage medium having instructions for execution by a processor for a product purchase study by a panel, the panel specifying product purchase information collection requirements, wherein the processor:
receives first product purchase information for a plurality of purchased products from one or more active information sources associated with a panelist;
compares the first product purchase information for each of the plurality of purchased products to a product definition database to identify the purchased products;
determines a completeness of the first product purchase information in describing each of the products based on the comparison;
acquires second product purchase information for one or more of the plurality of purchased products from one or more passive information sources; and
combines the first and second product purchase information to describe a purchase action in which the product was purchased.

20. The computer-readable storage medium of claim 19, wherein the first product purchase information is derived from a scan of a data element of the product, and wherein the processor determines an extent of compliance with the specified information collection requirements of the study
